(19) United States
(12) Patent Application Publication
(10) Pub. No.: US 2025/0150945 A1
(43) Pub. Date: May 8, 2025

(54) SYSTEMS AND METHODS FOR SYSTEM INFORMATION REPETITION

(71) Applicant: ZTE CORPORATION, Shenzhen (CN)

(72) Inventors: Fangyu CUI, Shenzhen (CN); Nan ZHANG, Shenzhen (CN); Wei CAO, Shenzhen (CN); Yachao YIN, Shenzhen (CN)

(73) Assignee: ZTE CORPORATION, Shenzhen (CN)

(21) Appl. No.: 19/012,709

(22) Filed: Jan. 7, 2025

Related U.S. Application Data
(63) Continuation of application No. PCT/CN2022/104723, filed on Jul. 8, 2022.

(51) Int. Cl. H04W 48/12; H04W 72/232

(52) U.S. Cl. CPC H04W 48/12; H04W 72/232

(57) ABSTRACT

Presented are systems and methods for system information repetition. A wireless communication device may identify a number of system information (SI) windows for repetitive transmissions of a system information block (SIB). The wireless communication device may determine an epoch time based on at least one of the SI windows.

### CROSS-REFERENCE TO RELATED APPLICATION

This application claims the benefit of priority under 35 U.S.C. § 120 as a continuation of PCT Patent Application No. PCT/CN2022/104723, filed on Jul. 8, 2022, the disclosure of which is incorporated herein by reference in its entirety.

### TECHNICAL FIELD

The disclosure relates generally to wireless communications, including but not limited to systems and methods for system information repetition.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a UE) may identify a number of system information (SI) windows for repetitive transmissions of a system information block (SIB). The wireless communication device may determine an epoch time based on at least one of the SI windows. The wireless communication device may identify the at least one of the SI windows according to at least one of a modification period and the number of the SI windows.

In some embodiments, the wireless communication device may receive the number of the SI windows via a signaling from a wireless communication node (e.g., a network). The signaling may comprise at least one of: a dedicated radio resource control (RRC) signaling, a master information block (MIB) signaling, or a system information block (SIB) signaling.

In some embodiments, the SIB may comprise at least one of: common timing advance (TA) parameters, ephemeris data, or epoch time information. The wireless communication device may determine the number of the SI windows for repetitive transmissions of the SIB according to the ephemeris data.

In some embodiments, the wireless communication device may determine a transmission setting for coverage enhancement (CE). The wireless communication device may the number of the SI windows for repetitive transmissions of the SIB according to the transmission setting for CE. The transmission setting for CE may comprise one of CE level 0, CE level 1, CE level 2, or CE level 3. The transmission setting for CE may comprise one of CEModeA or CEModeB. In some embodiments, the wireless communication device may determine the number of the SI windows for repetitive transmissions of the SIB according to the transmission setting for CE using a mapping configuration for a plurality of candidate transmission settings.

In some embodiments, the at least one of the SI windows may comprise at least one of: a first SI window of the SI windows, a last SI window of the SI windows, or a middle SI window of the SI windows. The epoch time may correspond to at least one of: a start time of the at least one of the SI windows, or an end time of the at least one of the SI windows.

In some embodiments, the epoch time information may comprise at least one of: a system frame number (SFN), or a subframe number. The SFN may correspond to at least one of: a current SFN of a frame where a message indicating the epoch time information in the at least one of the SI windows can be received, a next upcoming SFN after the frame where the message indicating the epoch time information in the at least one of the SI windows can be received, a latest previous SFN before the frame where the message indicating the epoch time information in the at least one of the SI windows can be received, or a nearest SFN to the frame where the message indicating the epoch time information in the at least one of the SI windows can be received. The epoch time may correspond to at least one of: a start time of a downlink (DL) subframe determined by the epoch time information or an end time of the DL subframe.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example representation of system information repetition, in accordance with some embodiments of the present disclosure;

FIG. 5 illustrates an example representation of system information repetition, in accordance with some embodiments of the present disclosure;

FIG. 6 illustrates an example representation of system information repetition, in accordance with some embodiments of the present disclosure;

FIGS. 7A-7B illustrate aspects of configurations for system information repetition, in accordance with some embodiments of the present disclosure;

FIG. 8 illustrates an example representation of system information repetition, in accordance with some embodiments of the present disclosure; and

FIG. 9 illustrates a flow diagram for system information repetition, in accordance with an embodiment of the present disclosure.

### DETAILED DESCRIPTION

### 1. Mobile Communication Technology and Environment

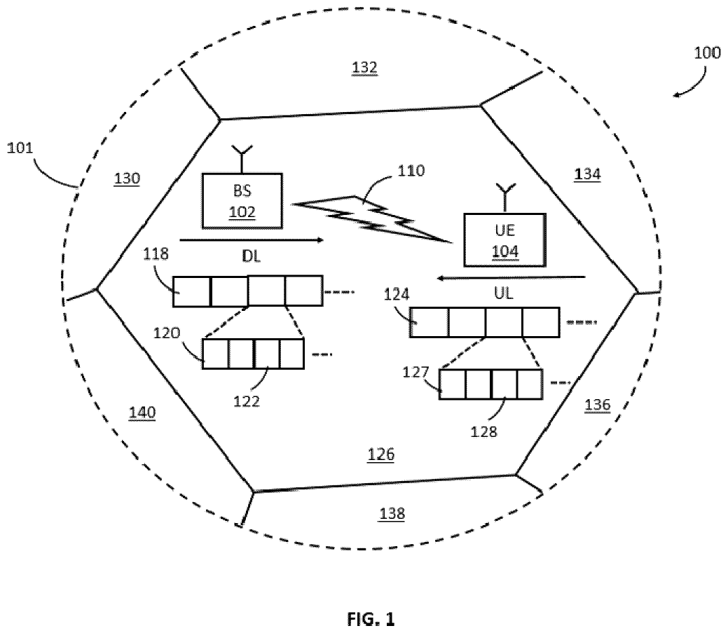

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

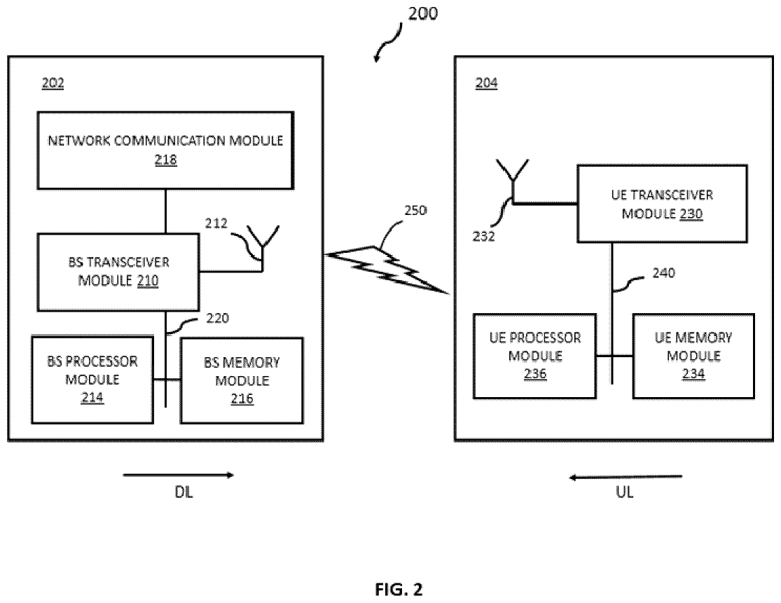

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for System Information Repetition

In non-terrestrial networks (NTN), common timing advance (TA) and ephemeris can be agreed to be indicated in system information block (SIB) to enable time and frequency pre-compensation at a UE. Due to high mobility of satellite, a validity duration of common TA and ephemeris can be short in low earth orbit (LEO) case. In such case, for a SIB update mechanism where parameters are updated at a start time of each modification period, an uplink (UL) synchronization can be hard to be kept since the modification period can be much longer than the validity duration. In order to keep the UL synchronization, 3GPP specification allows common TA and ephemeris parameters to be updated at any time within the modification period. The corresponding epoch time can be implicitly indicated as an end time of a system information (SI) window.

However, as the common TA and ephemeris parameters are allowed to be updated at any time, when the parameters are repeated across multiple SI windows, there can be an ambiguity issue since a UE cannot figure out which SI window is used for implicit epoch time indication. If repetitions across SI windows are not allowed, a coverage performance may degrade, which can be not preferred in Internet of Things (IoT) scenarios (e.g., massive Machine Type Communications (eMTC), narrowband IoT (NB-IoT), reduced capability (RedCap)). Hence, how to resolve the ambiguity issue without forbidding repetitions across SI windows is investigated in this disclosure.

### Non-Terrestrial Networks (NTN) Structure

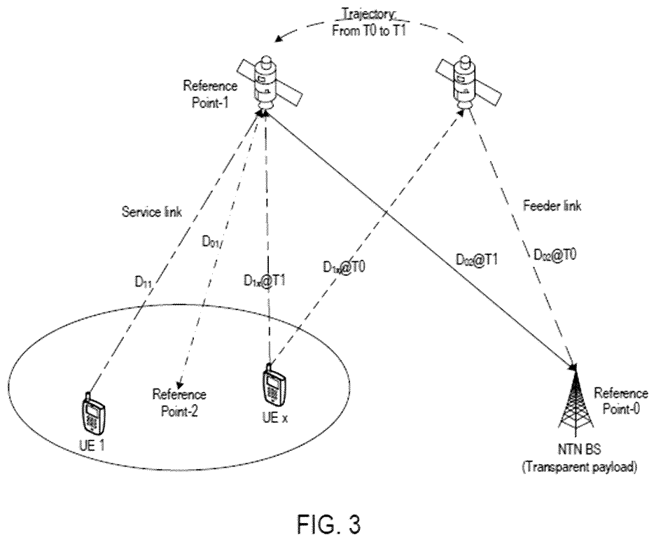

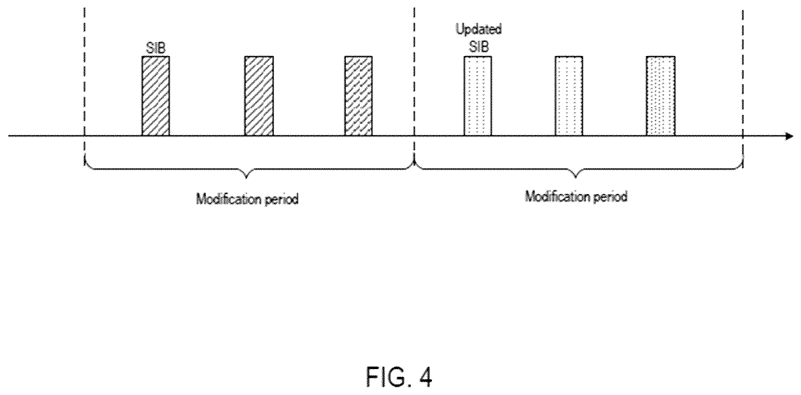

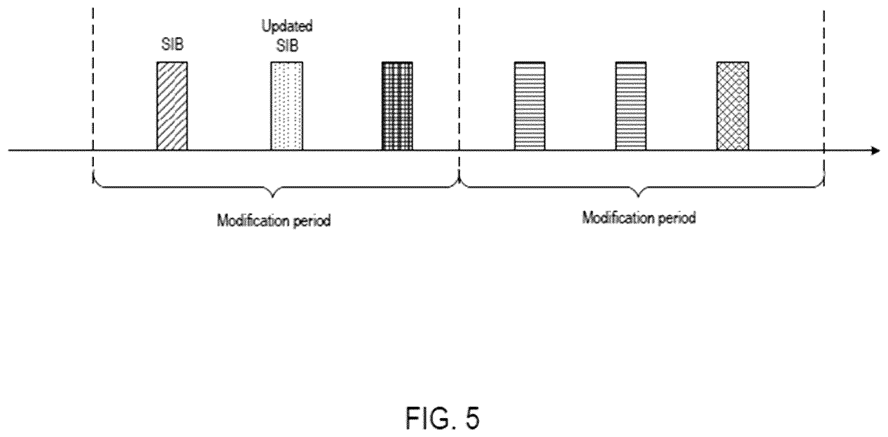

A structure of a transparent non-terrestrial network (NTN) is illustrated in FIG. 3. A link between a UE and a satellite can be a service link. A link between a BS and a satellite can be a feeder link. The feeder link delay can be common for all UEs within the same cell. In order to handle the long propagation delay, the BS may broadcast ephemeris parameters of satellite, which may help UEs to pre-compensate a service link delay. The BS may broadcast the common TA parameters, which may help UEs to pre-compensate a feeder link delay.

### System Information Block (SIB) Update Mechanism

In a terrestrial network (TN), a system information block (SIB) can be updated at the start of a modification period. During the modification period, the SIB can be considered invariant. While in a NTN, due to high mobility of satellite, a validity duration of common TA and ephemeris parameters can be generally shorter than a modification period especially in LEO case. In order to avoid loss of a UL synchronization, 3GPP specification supports the common TA and ephemeris parameters to be updated during modification period. Moreover, epoch time and validity duration can be indicated to let a UE know during which time the common TA and ephemeris parameters can be accurate enough.

### Indication of Epoch Time

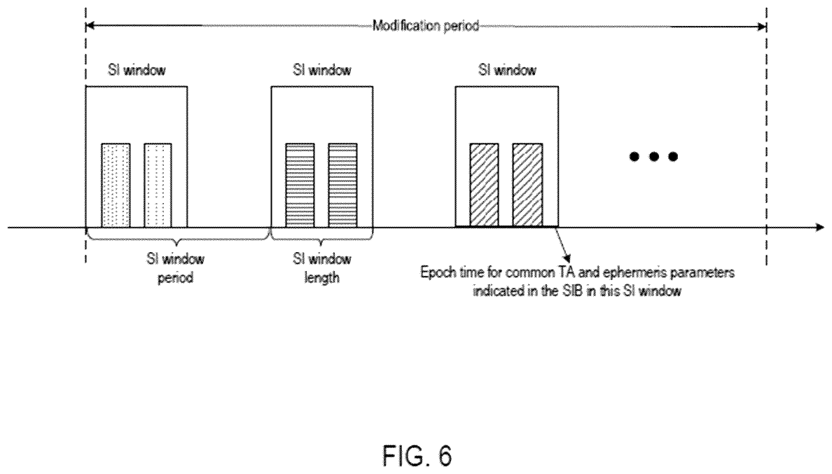

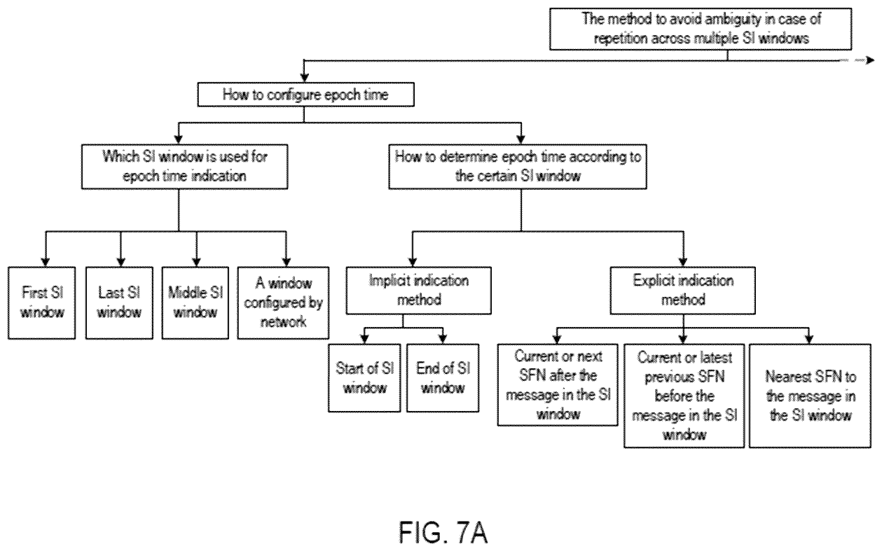

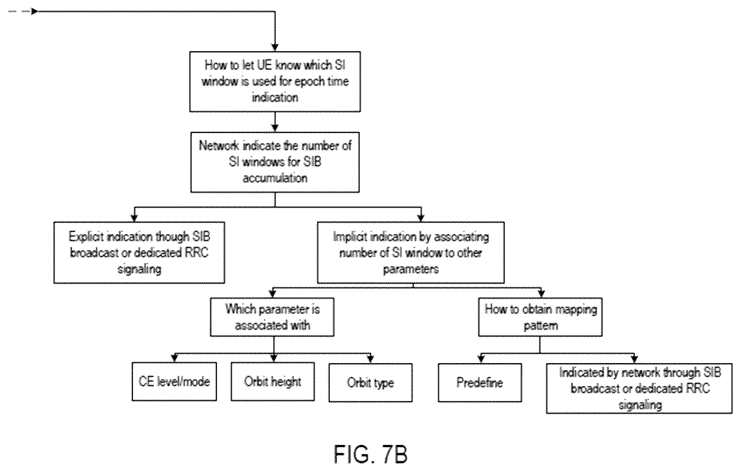

When common TA parameters and/or ephemeris parameters are indicated in a SIB, there can be two ways to indicate an epoch time. The first one can be an explicit indication. A system frame number (SFN) and a subframe index for the epoch time can be directly indicated along with common TA parameters and/or ephemeris parameters in the SIB. The epoch time may correspond to a start time of a downlink subframe indicated by the SFN and the subframe index. The second one can be an implicit indication. The epoch time of common TA parameters and/or ephemeris parameters indicated in SIB can be considered as an end time of corresponding SI window as shown in FIG. 6. The SIB containing common TA parameters and/or ephemeris parameters can be transmitted in a corresponding SI window. The SI window can be configured by the network through SIB1. A period and length of SI window can be invariant within a modification period. Within the SI window, the SIB transmission can be repeated according to a network configuration. However, since the SI window length is limited (e.g., at most 1600 ms in NB-IoT), the maximum repetition number (e.g., 2048 in NB-IoT) cannot be achieved within single SI window.

### Coverage Enhancement (CE) Level

In eMTC and NB-IoT, repetitive transmissions can be applied to enhance a coverage. For example, a physical downlink shared channel (PDSCH) can be configured to be transmitted 128 times to let a UE combine the repetitive transmissions in detection. When the repetition number is large enough, a receiver can be able to decode the message at a very low signal-to-noise ratio (SNR). A high path loss caused by a larger coverage range may be mitigated.

In order to handle different scenarios, multiple CE levels can be defined in NB-IoT and eMTC. In NB-IoT, there can be three types of CE levels (i.e., CE level 0, CE level 1, and CE level 2) to handle the scenarios where maximum coupling loss (MCL) equals to 144 dB, 154 dB, and 164 dB, respectively. In eMTC, there can be four types of CE levels (e.g., CE level 0, CE level 1, CE level 2, and CE level 3) defined for IDLE mode. In eMTC, there can be two types of CE modes (CEmodeA and CEmodeB) defined for RRC_CONNECTED mode. With different CE levels or CE modes, a UE and/or a BS may choose different repetition numbers to mitigate channel loss.

### Implementation Example 1: A Method to Avoid an Ambiguity when SI is Repeated Across SI Windows

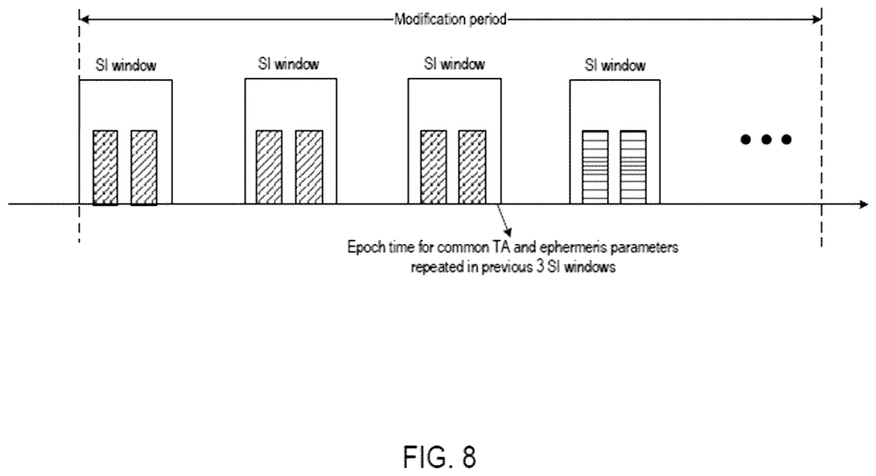

As mentioned above, the maximum repetition number for SIB may not be achieved within a single SI window due to a limited SI window length. A coverage performance may be degraded if repetitive transmissions across SI windows are not allowed. However, if repetitive transmissions across SI windows are allowed, different SI windows may indicate different epoch times for same common TA parameters and/or ephemeris parameters, which may cause an ambiguity issue. In order to avoid the ambiguity issue, an epoch time can be set as an end time of a specific SI window (e.g., the last SI window among the SI windows used for repetitive transmission of same common TA parameters and/or ephemeris parameters) as shown in FIG. 8.

The ambiguity issue may not be completely resolved by simply defining the epoch time as the end of a certain SI window since a UE may not know which SI window can be the one used for an epoch time indication. For example, in the case shown in FIG. 8, the end of last SI window can be configured as the epoch time for the common TA parameters and/or ephemeris parameters transmitted in the first three SI windows. However, if the UE does not know how many SI windows can be used for repetitive transmissions, the UE cannot figure out which can be the last SI window. In order to handle/resolve such issue, the network may broadcast a number of SI windows used for repetitive transmissions of the same SIB. In some embodiments, the network may indicate a number of SI windows used for repetitive transmissions of the same SIB via at least one of a master information block (MIB) signaling, a SIB signaling or a dedicated RRC signaling. In some embodiments, the number of SI windows may be broadcast in at least one of a SIB1, a SIB2, or the repetitively transmitted SIB. Since a SI window period and a start of modification period can be known by the UE, the UE can derive which SI window is the last SI window for repetitive transmissions of the same SIB (i.e., which SI window is used for epoch time indication). In certain embodiments, if other SI window (e.g., the first SI window among the SI windows used for repetitive transmission of same common TA parameters and/or ephemeris parameters) is used for an epoch time indication, the UE can also derive which SI window is the other SI window for repetitive transmissions of the same SIB. The SIB may comprise at least one of: common timing advance (TA) parameters, ephemeris data, or epoch time information. The common TA parameters may comprise at least one of: common TA, common TA drift, or common TA drift variation.

The following functions can be supported to handle/resolve the ambiguity issue when SIB repetition/accumulation across SI windows is allowed. The epoch time can be configured based on a certain SI window of the SI windows used for repetitive transmission of same SIB. The certain SI window may comprise at least one of: a first SI window of the SI windows, a last SI window of the SI windows, or a middle SI window of the SI windows. The certain SI window can be configured by the network through a SIB broadcast or a dedicated radio resource control (RRC) signaling. In some embodiments, the certain SI window may be predefined.

In some embodiments, if implicit epoch time indication method is used, the epoch time can be at least one of: a start time of the at least one of the SI windows (e.g., the certain SI window), or an end time of the at least one of the SI windows (e.g., the certain SI window).

In some embodiments, if explicit epoch time indication method is used, epoch time parameters can be indicated (e.g., system frame number (SFN) and subframe number). The SFN can be referring to at least one of: a current SFN of a frame where a message indicating the epoch time information in the at least one of the SI windows is received, a next upcoming SFN after a frame where a message indicating the epoch time information in the at least one of the SI windows is received, a latest previous SFN before a frame where a message indicating the epoch time information in the at least one of the SI windows is received, or a nearest SFN to a frame where a message indicating the epoch time information in the at least one of the SI windows is received. The epoch time information may comprise at least one of: a SFN, or a subframe number. In some embodiments, the epoch time may correspond to at least one of: a start time of a downlink (DL) subframe determined by the epoch time information or an end time of the DL subframe. The network may indicate the number of SI windows used for repeating the SIB carrying common TA parameters and/or ephemeris parameters via at least one of a MIB signaling, a SIB signaling, or a dedicated RRC signaling. In some embodiments, the number of SI windows may be broadcast in at least one of a SIB1, a SIB2, or a SIB carrying common TA parameters and/or ephemeris parameters.

### Implementation Example 2: Implicit Indication of a Number of SI Windows for SIB Repetitive Transmissions

Besides explicitly indicating how many SI windows can be used for SIB repetitive transmissions as illustrated in implementation example 1, implicit configuration method can also be considered. A SIB repetition/accumulation across multiple SI windows can be needed for SI decoding when a coverage is poor. Therefore, the number of SI windows for the SIB repetition/accumulation can be associated with other coverage related parameters to achieve implicit configuration.

For example, the number of SI windows can be mapped to coverage enhancement (CE) levels or CE modes. A transmission setting for CE may comprise one of CE level 0, CE level 1, CE level 2, or CE level 3. In some embodiments, a transmission setting for CE may comprises one of CEModeA or CEModeB. For high CE levels/modes, more number of SI windows may be used for the SIB repetition/accumulation since the coverage is poor. For low CE levels/modes, fewer SI windows may be used for the SIB repetition/accumulation since the coverage is better. A mapping pattern between detailed number of SI windows and CE levels/modes (e.g., as shown in Table 1) can be predefined or configured by the network though a SIB broadcast/dedicated RRC signaling. The UE and the network may achieve consensus on how many SI windows can be used for the SIB repetition/accumulation when the CE levels/modes are known.

TABLE 1

| | Number of SI window for SIB |
|---|---|
| Coverage enhancement level | repetition/accumulation |
| CE level 0 | X₀ |
| CE level 1 | X₁ |
| CE level 2 | X₂ |

In some embodiments, the number of SI windows can be associated with orbit heights/satellite types. When a satellite has a higher orbit and a lower transmission power, the coverage may be poor and more number of SI windows can be used for the SIB repetition/accumulation. Otherwise, if a satellite has a lower orbit and a higher transmission power, the coverage may be good and fewer number of SI windows can be needed for the SIB repetition/accumulation. A satellite type can depend on a transmission frequency of the satellite. For example, if the transmission frequency is high, the SI repetition number can be lower.

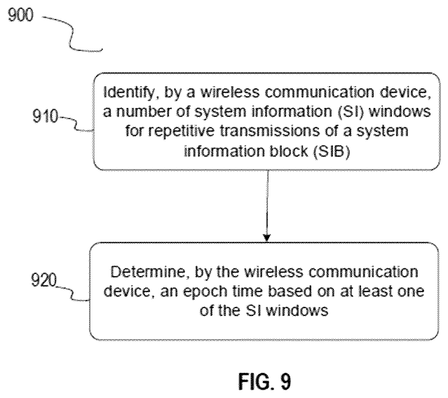

FIG. 9 illustrates a flow diagram of a method 900 for system information repetition. The method 900 may be implemented using any one or more of the components and devices detailed herein in conjunction with FIGS. 1-2. In overview, the method 900 may be performed by a wireless communication device, in some embodiments. Additional, fewer, or different operations may be performed in the method 900 depending on the embodiment. At least one aspect of the operations is directed to a system, method, apparatus, or a computer-readable medium.

A wireless communication device (e.g., a UE) may identify a number of system information (SI) windows for repetitive transmissions of a system information block (SIB). The wireless communication device may determine an epoch time based on at least one of the SI windows. The wireless communication device may identify the at least one of the SI windows according to at least one of a modification period and the number of the SI windows.

In some embodiments, the wireless communication device may receive the number of the SI windows via a signaling from a wireless communication node (e.g., a network). The signaling may comprise at least one of: a dedicated radio resource control (RRC) signaling, a master information block (MIB) signaling, or a system information block (SIB) signaling.

In some embodiments, the SIB may comprise at least one of: common timing advance (TA) parameters, ephemeris data, or epoch time information. The wireless communication device may determine the number of the SI windows for repetitive transmissions of the SIB according to the ephemeris data.

In some embodiments, the wireless communication device may determine a transmission setting for coverage enhancement (CE). The wireless communication device may the number of the SI windows for repetitive transmissions of the SIB according to the transmission setting for CE. The transmission setting for CE may comprise one of CE level 0, CE level 1, CE level 2, or CE level 3. The transmission setting for CE may comprise one of CEModeA or CEModeB. In some embodiments, the wireless communication device may determine the number of the SI windows for repetitive transmissions of the SIB according to the transmission setting for CE using a mapping configuration for a plurality of candidate transmission settings.

In some embodiments, the at least one of the SI windows may comprise at least one of: a first SI window of the SI windows, a last SI window of the SI windows, or a middle SI window of the SI windows. The epoch time may correspond to at least one of: a start time of the at least one of the SI windows, or an end time of the at least one of the SI windows.

In some embodiments, the epoch time information may comprise at least one of: a system frame number (SFN), or a subframe number. The SFN may correspond to at least one of: a current SFN of a frame where a message indicating the epoch time information in the at least one of the SI windows can be received, a next upcoming SFN after the frame where the message indicating the epoch time information in the at least one of the SI windows can be received, a latest previous SFN before the frame where the message indicating the epoch time information in the at least one of the SI windows can be received, or a nearest SFN to the frame where the message indicating the epoch time information in the at least one of the SI windows can be received. The epoch time may correspond to at least one of: a start time of a downlink (DL) subframe determined by the epoch time information or an end time of the DL subframe.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
identifying, by a wireless communication device, a number of system information (SI) windows for repetitive transmissions of a system information block (SIB); and
determining, by the wireless communication device, an epoch time based on at least one of the SI windows.

2. The method of claim 1, comprising:
identifying, by the wireless communication device, the at least one of the SI windows according to at least one of a modification period and the number of the SI windows.

3. The method of claim 1, comprising:
receiving, by the wireless communication device from a wireless communication node, the number of the SI windows via a signaling.

4. The method of claim 3, wherein the signaling comprises at least one of: a dedicated radio resource control (RRC) signaling, a master information block (MIB) signaling, or a system information block (SIB) signaling.

5. The method of claim 1, wherein the SIB comprises at least one of: common timing advance (TA) parameters, ephemeris data, or epoch time information.

6. The method of claim 5, comprising:
determining, by the wireless communication device, the number of the SI windows for repetitive transmissions of the SIB according to the ephemeris data.

7. The method of claim 1, comprising:
determining, by the wireless communication device, a transmission setting for coverage enhancement (CE); and
determining, by the wireless communication device, the number of the SI windows for repetitive transmissions of the SIB according to the transmission setting for CE.

8. The method of claim 7, wherein the transmission setting for CE comprises one of CE level 0, CE level 1, CE level 2, or CE level 3.

9. The method of claim 7, wherein the transmission setting for CE comprises one of CEModeA or CEModeB.

10. The method of claim 7, comprising:
determining, by the wireless communication device using a mapping configuration for a plurality of candidate transmission settings, the number of the SI windows for repetitive transmissions of the SIB according to the transmission setting for CE.

11. The method of claim 1, wherein the at least one of the SI windows comprises at least one of: a first SI window of the SI windows, a last SI window of the SI windows, or a middle SI window of the SI windows.

12. The method of claim 1, wherein the epoch time corresponds to at least one of: a start time of the at least one of the SI windows, or an end time of the at least one of the SI windows.

13. The method of claim 5, wherein the epoch time information comprises at least one of: a system frame number (SFN), or a subframe number.

14. The method of claim 13, wherein the SFN corresponds to at least one of: a current SFN of a frame where a message indicating the epoch time information in the at least one of the SI windows is received, a next upcoming SFN after the frame where the message indicating the epoch time information in the at least one of the SI windows is received, a latest previous SFN before the frame where the message indicating the epoch time information in the at least one of the SI windows is received, or a nearest SFN to the frame where the message indicating the epoch time information in the at least one of the SI windows is received.

15. The method of claim 5, wherein the epoch time corresponds to at least one of: a start time of a downlink (DL) subframe determined by the epoch time information or an end time of the DL subframe.

16. A wireless communication device, comprising:
at least one processor configured to:
identify a number of system information (SI) windows for repetitive transmissions of a system information block (SIB); and
determine an epoch time based on at least one of the SI windows.

17. The wireless communication device of claim 16, comprising:
identifying, by the wireless communication device, the at least one of the SI windows according to at least one of a modification period and the number of the SI windows.

18. The wireless communication device of claim 16, comprising:
receiving, by the wireless communication device from a wireless communication node, the number of the SI windows via a signaling.

19. The wireless communication device of claim 18, wherein the signaling comprises at least one of: a dedicated radio resource control (RRC) signaling, a master information block (MIB) signaling, or a system information block (SIB) signaling.

20. The wireless communication device of claim 16, wherein the SIB comprises at least one of: common timing advance (TA) parameters, ephemeris data, or epoch time information.
